(19) United States
(12) Patent Application Publication
(10) Pub. No.: US 2008/0288322 A1
(43) Pub. Date: Nov. 20, 2008

(54) METHODS AND SYSTEMS FOR PROJECT MANAGEMENT

(75) Inventors: Kevin Kennedy, Indianapolis, IN (US); Niles Ingalls, Indianapolis, IN (US)

Correspondence Address: ICE MILLER LLP, ONE AMERICAN SQUARE, SUITE 3100, INDIANAPOLIS, IN, 46282-0200, US

(73) Assignee: Kevin Kennedy & Associates, Inc., Indianapolis, IN (US)

(21) Appl. No.: 12/118,386

(22) Filed: May 9, 2008

Related U.S. Application Data
(60) Provisional application No. 60/917,222, filed on May 10, 2007.

(51) Int. Cl. G06F 17/30; G06Q 10/00; G06F 15/16

(52) U.S. Cl. 705/9; 705/1; 705/8; 709/201

(57) ABSTRACT

Systems and methods for facilitating the management of project resources such that high levels of supervision and project management may be achieved. Embodiments of the systems and methods further enable rapid response project management through the interaction of a client relationship management system, a phone system, an email communication system, and an analysis system. Further, in at least one embodiment, a résumé and notice of client contact automation system may be integrated with the various other components to facilitate project resource selection and client satisfaction.

### RELATED APPLICATIONS

This U.S. Utility patent application claims priority to U.S. Provisional Patent Application 60/917,222, which was filed May 10, 2007. The contents of this application is hereby incorporated by reference in its entirety into this disclosure.

### BACKGROUND

Effective communication between a business and its clients is critical to maintaining a sufficient working relationship and client satisfaction. While technology facilitates the ease of communication between businesses and their clients, it does not provide much in the way of a standardized format or tracking capabilities. Large project scopes and the lack of a universal communication protocol often present barriers to effective communication between a business and its clients, thereby resulting in a breakdown of communication, decreased efficiency, and reduced client satisfaction.

Communication breakdown is particularly problematic where a business provides team-based project management services to its clients. In such situations, increased efforts on the part of the team members are required to ensure that effective client communication is achieved. For example, in the consulting industry, it is not uncommon for a team of ten or more individuals to be assigned to a particular client project. Moreover, depending on the breadth and scope of the project, numerous teams may be working concurrently on different, yet related, projects for the same client. To complicate matters all the more, it is also common for various team members to be located in distributed environments, with project managers and the individuals they manage distributed geographically (e.g., one member of the team based at a client site or in a foreign country due to outsourcing). In such situations, it is exceptionally important that communication with the client and between team members is strong such that aspects of a project are not overlooked or inadvertently ignored.

Additionally, it is not uncommon for specific client requests to be overlooked due to team members assuming such requests are being addressed by other members of the team because of the number of managers and team members assigned to a particular client project. Accordingly, regardless of the number of team members involved with a particular project and their geographical location, it is pertinent that all project managers and team members communicate with one another so that each member understands the client's needs. It would be desirable to have a method for monitoring client communications relative to a project which is capable of immediately determining the status and details of such a project. It would also be desirable to have a method that ensures a high level of client customer service by facilitating rapid response times to clients' inquiries and needs.

### BRIEF DESCRIPTION OF THE DRAWINGS

FIG. 1 shows a schematic view of an embodiment of a project management system;

FIG. 2 shows a schematic view of an optional embodiment of a project management system;

FIG. 3 shows one example of a graphic user interface for accessing the functionality of a project management system;

FIG. 4 shows one example of a “Contacts” field of a graphic user interface for accessing the functionality of a project management system;

FIG. 5 shows an example of a project tab of a project management system as presented through one graphic user interface;

FIG. 6 shows a flow chart of a project management method for monitoring electronic communications among members of a project team and client contacts;

FIG. 7 shows a flow chart of an embodiment of the project management method for monitoring electronic communications among members of project team and client contacts of FIG. 6;

FIG. 8 shows a flow chart of one embodiment of a method for monitoring facsimile communications that may be added on to the methods of FIGS. 6 and 7;

FIG. 9 shows a flow chart of one embodiment of a method for monitoring electronic communications and ensuring rapid response times to client inquiries that may be added on to the methods of FIGS. 6, 7 and 8;

FIG. 10 shows a flow chart of one embodiment of a method for distributing affiliate résumés and notices of client contact that may be added on to the methods of FIGS. 6, 7, 8, and 9; and

FIG. 11 shows a schematic view of a project management system further comprising a résumé and notices of client contact automation system.

### SUMMARY

Methods and systems are provided for project management using a communication system. For example, a management system is provided that comprises a server network, a plurality of personal computer terminals operatively coupled with the server network, a plurality of applications coupled with the server network, an intranet system, and at least one database. In this management system, the intranet system is coupled with the server network and the plurality of applications. Further, each of the at least one databases is operatively coupled with the server network and is capable of being accessed thereby.

At least one of the plurality of applications may comprise a client relationship management system. Further, at least one of the plurality of applications may comprise a phone system. Still further, at least one of the plurality of applications may comprise an email communication system. The applications may be capable of communication with each other over the intranet or otherwise. For example, and without limitation, some or all of the applications may be coupled with each other.

In at least one embodiment, at least one of the applications may comprise an analysis system and/or a résumé and notice of client contact automation system. In this example, the résumé and notice of client contact automation system may be operable to retrieve a file from the databases, retrieve relevant information from the databases, and interface with the email communication system such that a communication based on the relevant information and having a file attached can be sent.

Methods for project management are also disclosed herein. Embodiments of a method for project management may include providing a communication system; receiving communications through the communication system; converting the communications into at least one electronic medium; extracting relevant information from the converted electronic communications, such as an identification of the parties to the communications or a time and/or date on which the communications were made; storing the relevant information in a database; automatically populating at least one defined field of a management system with the relevant information; and, monitoring the frequency of communications with the management system. The subject communications of the method may comprise electronic-mail based communications, telephone based communications, facsimile based communications, or any other communication medium through which communications may be sent and/or received.

In one example, the step of the project management method comprising monitoring the frequency of the communications with the management system may comprise identifying a first party, a second party, and a client; monitoring the communications between the first party and the client based on the relevant information during a first stage of a project; and, monitoring the communications between the second party and the client based on the relevant information during a second stage of the project. Furthermore, the method may identify a required response time; identify a third party to be notified; and, issue a communication to the third party in the event the communications between the first party and the client does not comprise a telephonic communication within the required response time.

The method may also comprise the steps of establishing at least one milestone for a project and assessing the stored information to determine a status of the project relative to the at least one milestone. Further, the method may comprise the steps of defining at least one required response time to the communications received through the communication system; identifying at least one party; and, issuing an alert to the at least one party in the event the communication is received by the communication system and not responded to within the required response time.

The method may also include steps for the evaluation of information. For example, the method may include evaluating the relevant information stored in the database on a periodic basis; creating a report indicating any detected changes in the stored information; and, sending the report to a plurality of specified parties. Additionally, the project management method may also provide steps for automatically soliciting individuals to participate on a project and/or automatically sending information to a client. For example, the method may include the steps of selecting at least one individual to participate on a project; retrieving at least one résumé for each of the at least one individuals from the database; attaching the résumés to a communication; and, sending the communication to at least one client for the project. Further, the method may comprise the step of sending each of the individuals a communication regarding the project and/or the step of validating that the communication was sent to the at least one client.

### DETAILED DESCRIPTION

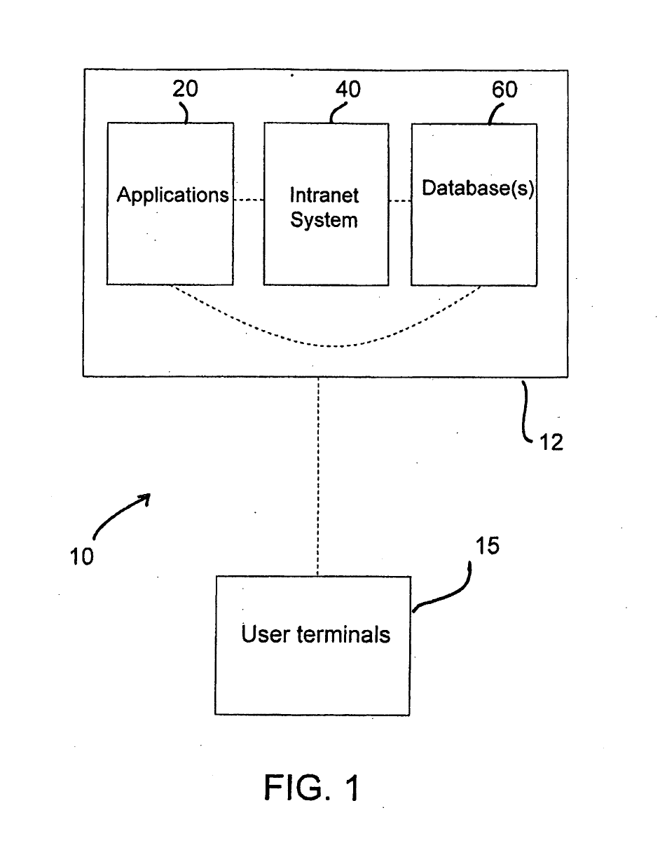

FIG. 1 shows a schematic view of one embodiment of a project management system 10. The project management system 10 is a system that can manage project resources, perform high levels of project supervision, and facilitate rapid response project management. Specifically, the project management system 10 comprehensively tracks all electronic communication among members of a project team and client contacts, thereby enabling the highest levels of project supervision, client relations and efficiency.

The project management system 10 comprises a server network 12 that may include one or a plurality of central computer servers. The server network 12 is operatively coupled with a plurality of personal computer terminals 15 and is capable of executing various applications. In one embodiment, the server network 12 of the project management system 10 is operatively coupled with the computer terminals 15 over a networking infrastructure (e.g., the Internet, intranet, or other connection). In this embodiment, the project management system 10 uses a virtual private network to communicate data over the networking infrastructure such that a user can communicate with the project management system 10 over a secure and encrypted connection. In an alternative embodiment, the server network 12 is operatively coupled and accessible to the computer terminals 15 and applications through a server-centric computing component, such as Microsoft Windows Terminal Services.

As shown in FIG. 1, the server network 12 of the project management system 10 comprises a plurality of applications 20, an intranet system 40, and at least one database 60. The server network 12, each of the plurality of applications 20 and the databases 60 are each linked together via Transmission Control Protocol and Internet Protocol (TCP/IP). It will be appreciated by one skilled in the art that other embodiments of the project management system 10 can utilize other means to link application 20 and database 60 together. For example, the project management system 10 may call web services to interact with the application 20 and the database 60. In this manner, the server network 12, the plurality of applications 20 and the databases 60 are all capable of directly communicating with each component of the project management system.

The applications 20 are any software packages that are able to integrate the various components of the project management system 10 and are capable of communicating with the intranet system 40 and the databases 60. The applications 20 may be individually loaded onto separate servers within the server network 12, or the applications 20 may be loaded onto a single server. Embodiments of the applications 20 will be discussed in further detail herein.

The intranet system 40 is a private computer network that uses Internet protocols, network connectivity, and a public telecommunication system to securely transfer data between users as is commonly known in the art. In one embodiment, the intranet system 40 is an organizational intranet system, such as a Windows server with Microsoft Windows Terminal Server access, and is capable of functioning as a single-point information system for the project management system 10. In this manner, a user can log onto the server network 12 through the intranet system 40 and obtain access to all of the services offered by the project management system 10. While this embodiment comprises an intranet system 40 to transfer data between users, the project management system 10 does not require a networking infrastructure, such as an intranet, to track electronic communications or facilitate rapid response systems.

Each database 60 comprises any database commonly known in the art that is capable of being accessed by the applications 20 and the intranet system 40. The databases 60 may further comprise a plurality of individual, unrelated databases and some or all of the databases 60 may be associated with specific applications 20. In addition, one or more of the databases 60 may be remotely located with respect to the project management system 10, provided that the server network 12 and the applications 20 are capable of accessing the remote databases 60 over a connection. Many types of connections are well known in the art to facilitate such access.

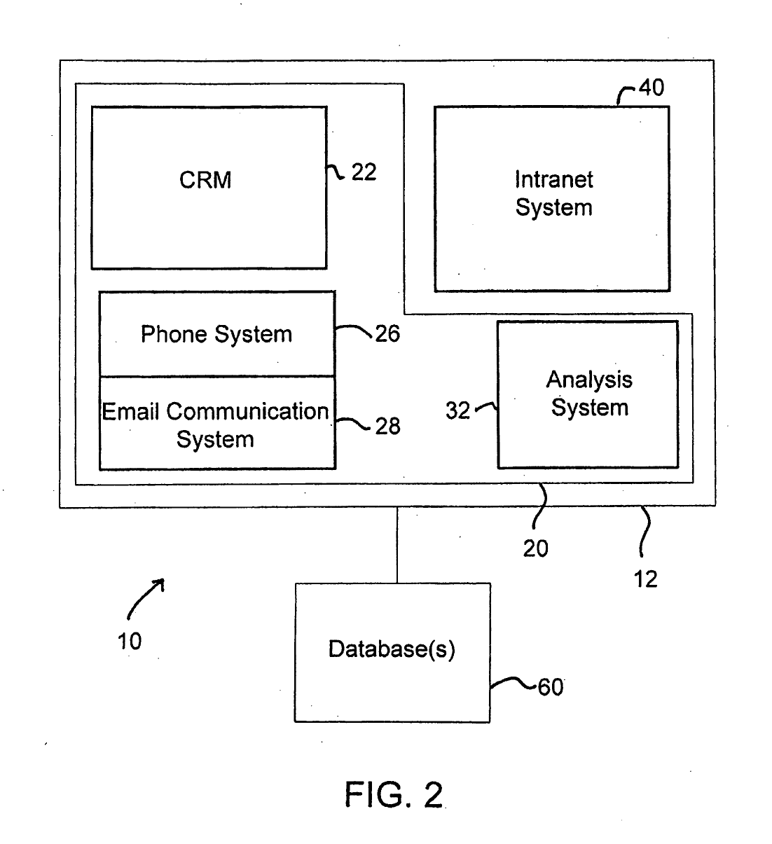

Now referring to FIG. 2, the project management system 10 is shown with examples of applications 20 that can be included with the project management system 10. In this embodiment, the applications 20 of the project management system 10 comprise a client relationship management system 22 (the “CRM 22”), a phone system 26, an email communication system 28, and an analysis system 32. The CRM 22 comprises an interface and may be any CRM software package known in the art, including but not limited to, Sage SalesLogix® CRM (SLX) and Microsoft® CRM (MSCRM). While CRM 22 is used in this embodiment, it will be appreciated by anyone skilled in the art that any similar system could be used. In one embodiment, the CRM 22 also has its own database (the “CRM database”). The CRM database may be integrated with the CRM 22, or it may be independent thereof and accessible by the CRM 22 over a secure connection. Specifically, the CRM 22 is capable of retrieving information from a database 60 of system 10 and storing such information in the CRM database in an organized manner.

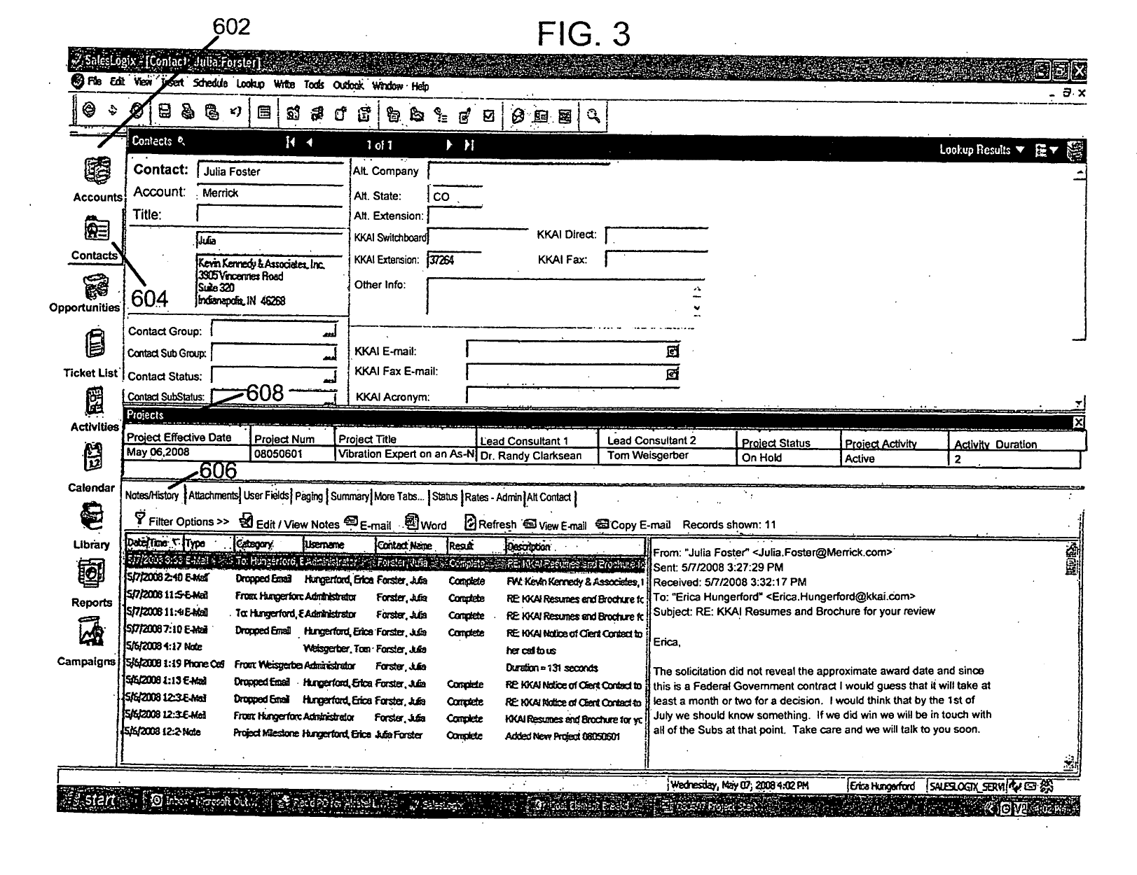

In one embodiment, the CRM 22 organizes client contact information stored in the CRM database into individual records. These records may contain categories and subcategories of tabs and fields. FIG. 3 illustrates one example of a graphic user interface (“GUI”) for accessing the functionality of the CRM 22. It will be understood that the GUI displayed in FIG. 3 is merely offered by way of a non-limiting, explanatory example and that any type of presentation layer can be used.

As shown in FIG. 3, a record may contain a first tab 602 labeled “Accounts”, a second tab 604 labeled “Contacts”, and a third tab 606 labeled “Notes/History”. In this embodiment, the second tab 604 “Contacts” is a subcategory of the first tab 602 “Accounts”, and the third tab 606 “Notes/History” is a subcategory of the second tab 604 “Contacts”. The first tab 602 “Accounts” can comprise any subdivision of information, such as a client's company name. Each “Account” is then divided into the second tab 604 “Contacts”. Each of the “Contacts” tabs 604 may be associated with particular individuals at a client company. The second tab 604 “Contacts” may further be subdivided into a plurality of tables. One such table comprises the third tab 606 “Notes/History”.

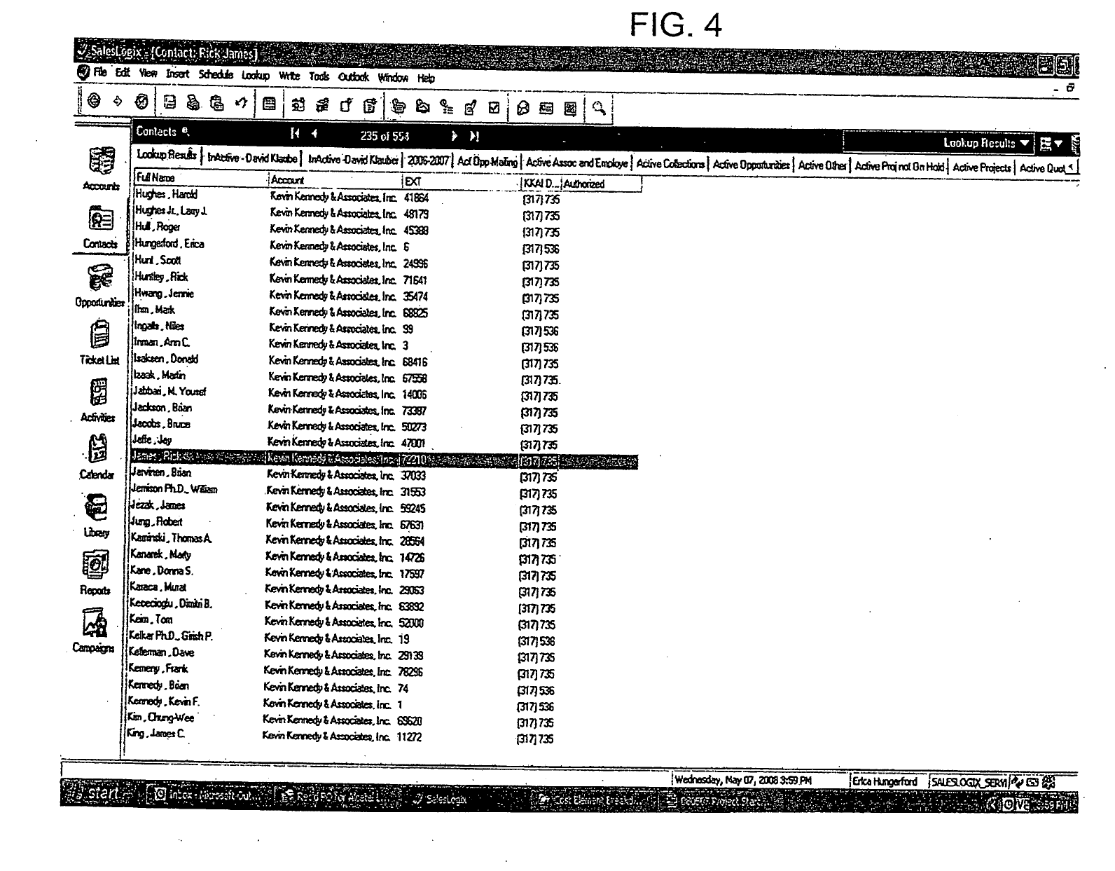

The rows of the “Notes/History” table each comprise a separate field, each field being labeled by a column heading. For example, the different column headings of the “Notes/History” table may include: Date/Time, Type, Category, and Description. For example, a record may contain the contact information for a client company (“Company X”). In this example, the “Account” category would be named Company X and any general contact information for Company X would be recorded at the “Account” level. At the “Contacts” subcategory level, names of the employees of Company X may be listed in conjunction with each employee's direct contact information (see FIG. 4). As a subcategory of each “Contact” or record for an employee of Company X, the “Notes/History” table can function to store information with respect to each communication that the particular employee contact sends or receives. For example, in one embodiment that is described in more detail herein, the “Notes/History” table for each contact comprises “Résumé/NCC Status” and “Last Résumé Sent” fields. As explained below, the project management system 10 can utilize the various fields in the CRM 22, or another comparable organizational structure, to identify, process, label and store each communication that is sent and received through the project management system.

Optionally, the CRM 22 can also organize project status information into a “Notes/History” table associated with a particular “Contact” subcategory. In this manner, the “Notes/History” table(s) can be used to track the progression of a project through its various stages, or milestones, such that a user can easily identify what steps have and have not been completed. For example, the milestones may include completing conflicts checks, completing SpeedSearch, completing conference calls, and/or completing expanded scope discussion.

The different column headings of the “Notes/History” table may also include Milestone Notes, Last Milestone Completed, and Current Milestone Duration. Accordingly, as a project advances through its various stages, information can be logged into the appropriate fields so that a user can easily identify the steps that have been completed and the current status of the project. For example, when new project is added to an Account, information regarding the project may be entered under the Milestone Notes columns of the “Notes/History” tables of the applicable Contacts. Thereafter, as the project progresses and different tasks are completed, the Last Milestone Completed field may be updated. Further, the Milestone Duration field can be configured to calculate the number of calendar days that the current milestone is pending. In this manner, if a project is delayed, a user can easily assess during which milestone the setback occurred. Accordingly, each time a milestone is completed, the Milestone Duration field value may be reset to zero (0) days. The logging of the project status information can either be performed manually by a user, or automatically through the project management system 10, as explained in more detail below.

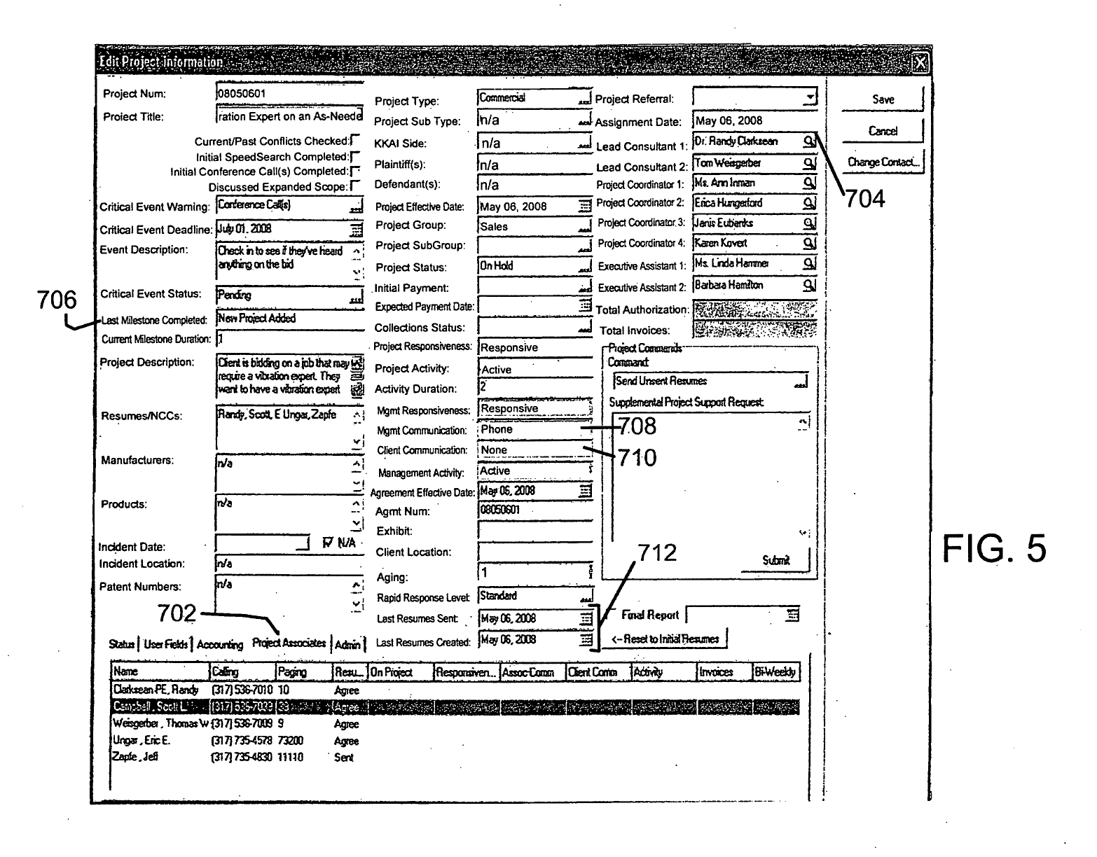

The CRM 22 may further comprise project tabs that are associated with each of the records stored in the CRM database. FIG. 5 illustrates one example of a presentation layer for a project tab. A project tab is a list of information specific to a particular project and may include the project specifications, identification of each of the team members working on the project, and the client contacts associated with the project. For example, one project sub-tab may be entitled “Project Associates” and comprise a list of each of the team members assigned to the project and a “Contact Search” field for searching and accessing specific records of the CRM 22. For example, see project sub-tab 702 of FIG. 5.

Additionally, the project tab may be used to assign leadership roles to the team members working on a project. The various leadership roles may be designated to specific team members through the use of fields. For example, as shown in FIG. 5, specific team members are associated with a particular leadership role through the use of fields 704. In this manner, a user can select the appropriate team member to be assigned as Lead Consultant 1 (“LC1”), Lead Consultant 2 (“LC2”), Project Coordinator (“PC1”), and so forth.

Now referring back to the “Contact Search” field, a user can easily search the CRM 22 database for specific Contacts, add the desired Contacts to the list of team members, and access detailed records on the potential team members, including the team members' resumes. It will be understood that the “Contact Search” field may comprise any number of subfields and, in one embodiment, comprises a first subfield labeled “First Name”, a second subfield labeled “Last Name”, a third subfield labeled “Location”, and a fourth subfield labeled “Position”. Accordingly, a user can specifically search for potential team members based on a single or various search criteria.

As will be described in more detail herein, the “Project Associates” sub-tab (see, for example, sub-tab 702 of FIG. 5) can further be used to solicit affiliates and managers to join the project and/or send potential team members' résumés to the client by completing a series of click-through steps on a project tab. To facilitate this process, the “Project Associates” sub-tab may further comprise a status field associated with each of the Contacts added thereto. For example, if a Contact is not currently staffed on a project and therefore is actively seeking an assignment, the Contact's status may be set to “Available” on the “Project Associates” sub-tab. Alternatively, if a Contact has been allocated to another project or is potentially unavailable, the Contact's status may be set to “Hold”. It will be understood that any number of status identifiers may be used to identify the status of a Contact on the “Project Associates” sub-tab and that the status identifiers can be tailored to fit the needs of particular clients and/or specific projects. In addition, to further facilitate the résumé process, the project tab may comprise a “Last Résumé Sent” field to assist in validating that a résumé email was successfully sent and integrated into the CRM 22.

The project tab may also include at least one field that indicates the current stage of a project. For example, and without limitation, the project stage may be “Sales”, “Quote”, or “Project/Production”. Further, the project tab may be linked to the “Notes/History” tables of specific contacts such that the Milestones of the project are easily accessible. This may be achieved through the assignment of a “Project Number” or any other categorical system. In at least one embodiment, the project tab may further comprise a field that automatically displays the last milestone completed based on information gathered from each of the relevant contacts (see field 706 of FIG. 5).

The project tab may also include at least one field for entry of information relative to the type of communication that occurs between the team members assigned to the project and the client contacts (the “Communication Type” field) (see, for example, fields 708 of FIG. 5). This Communication Type field may be in communication with the phone system 26 and the email communication system 28 and can be used to indicate whether the team members have adequately communicated with the client within a defined period of time. For example, in one embodiment, the Communication Type field can indicate that a team member contacted the client through email or over the telephone (the field would be populated with the term “Email” or “Phone”, respectively). In addition, a timeframe can be associated with the Communication Type field such that such communications must occur within a predetermined period of time. In the event the client is contacted by a team member via email and telephone within the requisite timeframe, the Communication Type field will then indicate “Both”. Further, the project tab may also comprise at least one field to monitor whether the client has initiated a communication with a team member within a defined period of time (the “Client Communication” field) (see, for example, field 710 of FIG. 5). Similar to the Communication Type field, the Client Communication field can display “Phone”, “Email”, or “Both” to indicate through which medium the client initiated contact. Further, the project tab may include a “Last Scheduled Date” field for indicating when the last résumé was scheduled to be sent to a client, as is discussed in more detail below (see, for example, fields 712 of FIG. 5).

In at least one embodiment, the project tab also includes a list of conditions that, if occur, will initiate the distribution of a warning message (the “trigger events”). For example, a trigger event may be defined by a user as, “Client does not receive any communication from a team member in three (3) days.” At the end of the third consecutive day that no communication had been received, the trigger event is satisfied and a warning message is sent that indicates the occurrence of the trigger event. Another example of a trigger event may include if there has been inadequate communication with a client. For example, a trigger event may be defined by a user as, “Phone communication has not occurred with the Client within a specific timeframe.” If, at the end of the specified timeframe, neither the Client Communication field nor the Communication Type field display “Phone” or “Both”, an appropriate warning message is sent indicating the occurrence of the trigger event. The trigger events may be set by any user of the system that has access to the project tab, for example, a project manager or an administrator.

A project tab may also contain a list of individuals to contact if a trigger event or change in project status occurs (the “Warning List”). The individuals on the Warning List are typically project managers, coordinators and administrative assistants; however, it will be recognized that any individual may be included thereon, depending on the project and desires of the client. One or more project tabs may be associated with each record of the CRM database.

The phone system 26 of the project management system 10 may comprise a Private Branch eXchange (“PBX”) telephone exchange, or any similar telephone system known in the art. In this embodiment, the phone system 26 is in communication with the intranet system 40 and at least one of the databases 60 (the “phone system database”) and is capable of creating phone logs and loading the phone logs into the server network 12. The email communication system 28 may be any application known in the art that is an electronic messaging system such as the Microsoft Exchange Server®. The email communication system 28 is operatively coupled with the intranet system 40 and at least one of the databases 60 (the “email communication system database”), and is capable of receiving electronic communications from the server network 12. In one embodiment, the system 10 may further comprise an Internet fax application that sits on top of the email communication system 28 platform and functions to convert facsimiles into email attachments. In this manner, the email communication system 28 is capable of receiving facsimiles as well as email messages.

The analysis system 32 may be comprised of a single application or a plurality of independent applications wherein at least one of the applications is modified such that the analysis system 32 is capable of interfacing with the phone system 26, the email communication system 28, and the CRM 22. In one embodiment, the analysis system 32 is capable of accessing and analyzing the electronic messages stored in the phone system database, the email communication system database, and the CRM database. While the project management system 10 is described as having one phone system 26, one email communication system 28, one CRM 22, and one analysis system 32, system 10 can be comprised of any number of phone systems 26, email communication systems 28, CRMs 22, facsimile systems and/or analysis systems 32. Moreover, while terms such as email communication system database, CRM database, and phone system database are used herein for ease of reference, it is understood that these databases may be separate, independent databases or combined within a single database.

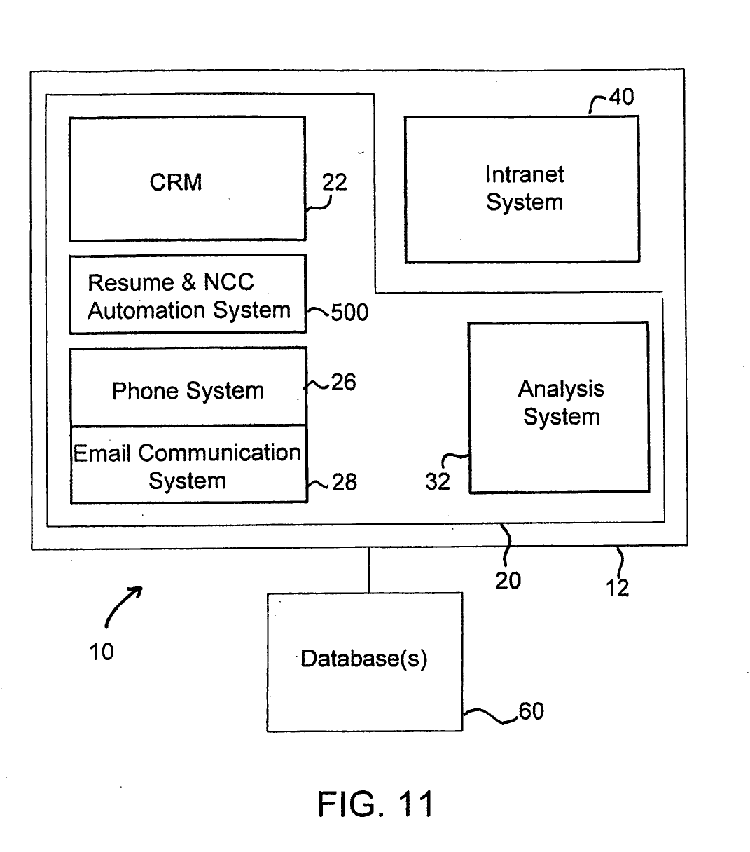

In an alternative embodiment (as shown in FIG. 11), a résumé and notice of client contact (“NCC”) automation system 500 may be included as an additional application 20 of the project management system 10. The résumé and NCC automation system 500 may be comprised of a plurality of independent applications wherein at least one of the applications is modified such that the résumé and NCC automation system 500 is capable of interfacing with the CRM 22 and the email communication system 28. In one embodiment, the résumé and NCC automation system 500 is capable of notifying affiliates of project opportunities and/or sending affiliate résumés to client contacts for review.

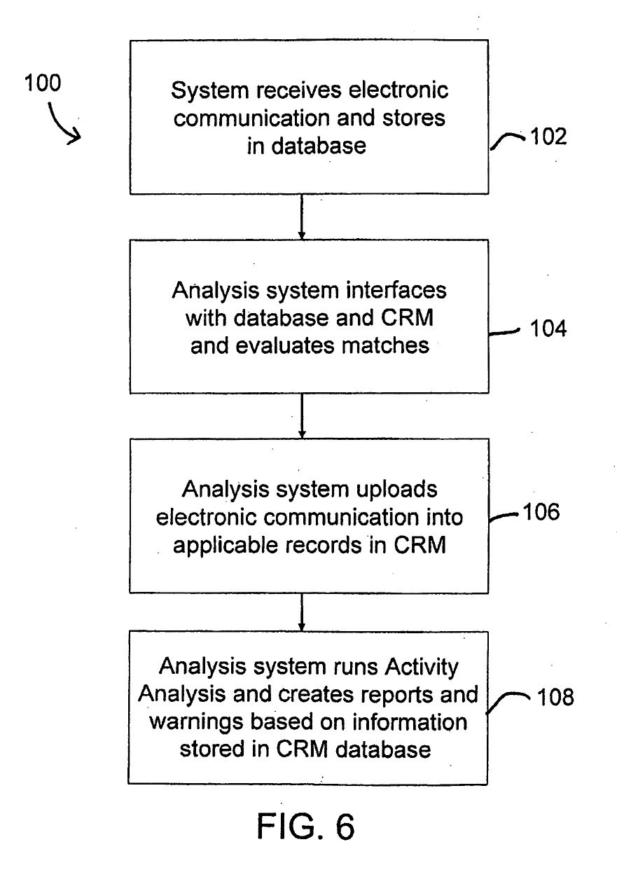

FIG. 6 shows a flow chart of one embodiment of a project management method 100 for monitoring electronic communications (e.g., telephone calls, voicemail messages, email messages, facsimiles, etc.) among members of a project team and client contacts. For ease of understanding, the steps of the related methods described herein will be discussed relative to components of the project management system 10 shown in FIGS. 1 and 2, but it will be appreciated by one skilled in the art that any such system can be used to perform these methods so long as it can receive electronic communications and can be programmed to execute the necessary steps.

Generally, a user can utilize the project management system 10 shown in FIGS. 1 and 2 to manage his or her electronic communications. As shown in FIG. 6, when an electronic communication is sent over the server network 12, the message is received by the project management system 10 and stored in the database 60 at step 102. At step 104, the analysis system 32 interfaces with both the database 60 containing the communication and the CRM 22, and evaluates the communication's information (e.g., the person the communication is to or from) against the CRM database for matches. When a match is found between the communication information and the records of the CRM database, the method 100 proceeds to step 106 and the electronic communication is uploaded into the applicable records of the CRM database.

In one embodiment of method 100, the analysis system 32 uses the identification information of the parties (e.g., caller's name, sender's name, recipient's email address, etc.) to identify the correct record(s) within the CRM database to associate with the communication. For example, the analysis system 32 may compare the sender's email address with all of the email addresses saved under the “Accounts” and “Contacts” categories in the CRM database. When a match is located, the method 100 proceeds to step 106 and the analysis system 32 uploads the electronic communication into the identified record of the CRM 22.

The analysis system 32 is capable of performing this data routing functionality with all recipients of a communication and the sender. Therefore, one communication may be associated with multiple records, all of which are updated with the communication information at step 106. Because each time the project management system 10 receives an electronic communication the method 100 is initiated, the method 100 is capable of updating the CRM 22 records on a real-time basis or otherwise. At step 108, the analysis system 32 performs an activity analysis on the CRM 22 records within the CRM database. During the activity analysis, specific records within the CRM database are analyzed pursuant to a set of rules. The specifics of the set of rules and the activity analysis functionality will be described in more detail below.

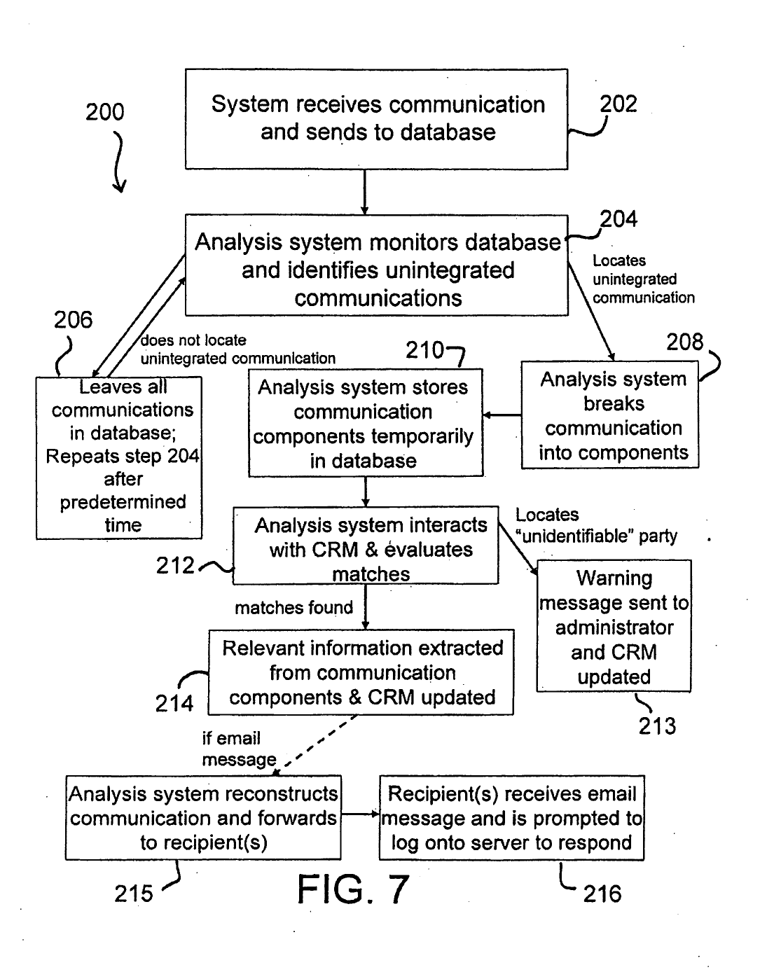

FIG. 7 shows a flow chart of another embodiment of a project management method 200. As shown in FIG. 7, when an electronic communication is sent over the server network 12, the communication is received at step 202 by the email communication system 28 if it is an email message or facsimile, or by the phone system 26 if it is a telephone call or voicemail message. The project management method 200 may be used in connection with various different types of electronic communications, but in the interest of clarity, the method 200 will first be described with respect to an email message.

At step 202, the email communication system 28 receives the email message and the relevant application 20 saves the email message into the email communication system database. In an embodiment where the email communication system 28 comprises a Microsoft Exchange Server®, when an email message is received by the email communication system 28, the message is archived to the email communication system database on a real-time basis, near real-time basis, or otherwise. At step 204, the analysis system 32 monitors the content of the email communication system database and identifies all “unintegrated” email messages contained therein. An “unintegrated” message is a communication that has been received by the project management system 10, but has not yet been stored within the records of the CRM 22. In the event the analysis system 32 does not locate an “unintegrated” email message in the email communication system database, at step 206 the messages are allowed to remain within the email communication system database and the analysis system 32 repeats step 204 after a predetermined amount of time. In one embodiment, the analysis system 32 performs step 204 in continuous intervals, such that the email communication system database is monitored by the analysis system 32 every ten (10) to fifteen (15) minutes. The integrated messages (i.e. a message that has been stored in the CRM 22) stored in the email communication system database may remain there indefinitely, be purged therefrom, or archived to the CRM database and/or a separate database 60 for database performance reasons.

If at step 204 the analysis system 32 identifies an unintegrated message, the method 200 proceeds to step 208 and the analysis system 32 breaks the unintegrated message into separate components. In one embodiment, the subject line, body, date/time, sender's name, recipient's name(s), and attachments of a message are separated such that these components can be used to populate the fields of the CRM database. Further, depending on from which database the unintegrated message was retrieved (i.e. the email communication system database or the phone system database), the analysis system 32 tags the message components as either “Email” or “Phone”. At step 210, the message components are temporarily stored in an access database 60 until they are needed. The access database 60 may be an independent database or any one of the databases 60 previously described, so long as the access database 60 is capable of associating with the email communication system 28 and the analysis system 32.

At step 212, the analysis system 32 interfaces with both the access database 60 and the CRM 22, and evaluates the message components against the CRM database for matches. When a match is found between a message component and a CRM database record, the method 200 proceeds to step 214 and the relevant information is extracted from the message components and used to populate the relevant fields of the CRM 22 database (e.g., the “Notes/History” table and/or the project tabs). The analysis system 32 is capable of performing this matching and updating function with all recipients of a message (both direct (to) and indirect (carbon copied or blind carbon copied)) and the sender. Therefore, one email message may be associated with multiple records, all of which are updated with the message information in step 214. Once the email message components are saved in the CRM 22 database, the original email message may be deleted from the email communication system database.

In one embodiment, the analysis system 32 uses the email address components to match the email message with the appropriate records within the CRM database. For example, if the recipients' and sender's email addresses have been previously stored in the CRM database, the analysis system 32 will recognize the matches, and at step 214, integrate the email message components into the sender's and recipients' records. Numerous email addresses may be associated with a single contact, for example, a personal email address and a general company email address may both be associated with a single contact record. In this manner, if a mass email message is sent to all of the employees of a client company via a general email address, as long as the general email address is associated with each of the employee's records in the CRM database, a record of the communication will be logged for each employee. In addition, receipt of the email communication will cause the Communication Type field of the project tab to be populated with the term “Email”, thus indicating that the client has received an email communication from a team member.

Referring back to step 212 of the method 200, in the event the analysis system 32 is unable to locate a match for the email message within the CRM database, the message is deemed unidentifiable. When the analysis system 32 locates an unidentifiable message, a warning message is created and sent to the administrator of the project management system 10 at step 213. In one embodiment, the administrator manually enters the unidentified party's contact information and the “Email” tag into the CRM database, thereby creating a new record and updating the “Communication Type” field on the project tab. In an alternative embodiment, the new entry process is automated such that the analysis system 32 automatically creates a new record containing the email message components of the unidentifiable message. In this manner, the analysis system 32 ensures that a new CRM database record is created with respect to the unidentified party and the details of the electronic communication are recorded therein.

An email message is considered unidentifiable even if only one party to the communication is not recognized within the CRM database. For example, even if one indirect recipient receiving a blind carbon copy of the email message is not recognized within the CRM database, the email message is deemed unidentifiable. When an unidentifiable party and identifiable party are both associated with an email message, the method 200 bifurcates between the identified party and the unidentifiable party. With respect to the unidentifiable party, the method 200 proceeds to step 213. However, with respect to the identified party, the method 200 proceeds to step 214.

Once the email message has an identifiable party and the components have been integrated into the CRM 22, the method 200 proceeds to step 215. At step 215, the analysis system 32 reconstructs the email message and the server system 12 forwards the intact email message to the intended recipient(s). The recipient's email account can either be an email account on the server network 12 or a personal email account off of the server network. In the event the recipient's email account is a personal account off of the server network, when the server system 12 forwards the email message to the recipient's personal account, this effectively functions as a warning to the recipient that he or she has received a message on his or her server account.

At step 216, the recipient receives the email message and is prompted to log onto the server network 12 to view and/or reply to the communication. If the recipient replies directly to the received email, he or she will receive a warning message from the system 10 that in order to respond it is necessary to log onto the network server 12 because the email message is sent to the recipient from the server network 12 and not directly from the sender. In one embodiment, when the server system 12 forwards the email message to the intended recipient, the sender's name and contact information (e.g., email address) is stripped therefrom to further encourage the email message recipient to log onto the server network 12 to respond. In the event the recipient desires to reply to the received email message, the recipient logs onto the server network 12 and sends a response email, thereby starting the method 200 over at step 202.

Method 200 of FIG. 6 may also be used in connection with monitoring incoming and outgoing telephone communications. In this embodiment, at step 202 the project management system 10 receives either an incoming or outgoing telephone communication through the phone system 26. When the phone system 26 receives the telephone call, a log of the call is created that contains details with respect to the communication. For example, for an incoming telephone call, the record may contain the telephone number of the party initiating the telephone call (which may be obtained through caller identification services), the party the caller is attempting to reach (the number dialed), and the date and time of the call. In one embodiment, the phone log is created by an onsite or offsite phone logging system, such as the PBX phone system. Once created, the log is temporarily stored in an accessible database 60. The accessible database 60 may be an independent database or any one of the databases 60 previously described, so long as it is capable of gathering information from the phone system 26.

At step 204, the analysis system 32 monitors the content of the accessible database 60 and identifies all unintegrated phone logs contained therein. Similar to an unintegrated email message, an unintegrated phone log is a record of a telephone call that has not yet been saved into the records of the CRM 22. In the event the analysis system 32 does not identify an unintegrated phone log within the accessible database 60, at step 206, the phone log is left within the accessible database 60 and the analysis system 32 repeats step 204 after a predetermined amount of time. In one embodiment, the analysis system 32 performs step 204 in continuous intervals, such that the accessible database 60 is monitored by the analysis system 32 every five (5) to ten (10) minutes. The integrated phone logs contained within the accessible database 60 may be purged from the access database 60 or archived to a separate database 60.

Alternatively, if, in step 204, the analysis system 32 identifies an unintegrated phone log, the method 200 proceeds from step 204 to step 214 as previously described with respect to the email message. Accordingly, the analysis system 32 breaks down the phone log into separate components and integrates the components into the CRM database (steps 208-214). Further, the analysis system 32 is capable of recognizing that the phone log components are a “Phone” communication, and the Communication Type field of the project tab in the CRM database is updated accordingly.

In the event the analysis system 32 operating with respect to the phone system 26 indicates an unidentifiable party within a phone log at step 212, the method 200 proceeds to step 213 and sends a warning message to administrators with respect thereto. Once the phone log information has been saved into the CRM 22, the phone log components are reassembled and saved in a telephone log table within the CRM 22. This telephone log table contains a complete list of all of the calls sent and received through the phone system 26 and each record may include details associated with the call. This telephone log table may be saved in the CRM 22 indefinitely or manually purged by a user, such as a system administrator.

The method 200 may also be used when a facsimile transmission is received by the project management system 10. As previously noted, in one embodiment, the project management system 10 further comprises an Internet fax application that cooperates with the email communication system 28. In this manner, the system 10 is capable of treating facsimiles similarly to email messages. When a facsimile is received by the server network 12 at step 202, the Internet fax application immediately converts the facsimile into an email attachment. Typically, such attachments are in a tagged image file format (“TIFF”) or portable document format (“PDF”), but it will be understood that any electronic file type may be used. Once the facsimile is converted into an email attachment, the email communication system 28 creates a new email message, attaches the facsimile-email attachment thereto, and associates a facsimile-email address with the email message based on the intended recipient of the facsimile (determined by the recipient's facsimile number). This new email message (the “fax-email message”) is then stored in the email communication system database.

At step 204, the analysis system 32 monitors the email communication system database, identifies the fax-email message as an unintegrated communication, and proceeds to step 208. From this step on in the method 200, the fax-email message is treated as an email message. At steps 208 through 212, the analysis system 32 breaks the fax-email message into components and uses the facsimile-email address to evaluate if the sender/recipient has a record within the CRM database. The sender's facsimile number is a field of a Contact's record in the CRM database and can be used for the matching function of step 212 in order to identify the correct records. Once the sender's and recipient's records are identified, the relevant records of the CRM database are updated with the details of the fax-email message at step 214, including the Communication Type field of the relevant project tab, which is populated with the term “Email”. Because the facsimile communication has been converted into an email message format, the method 200 proceeds to step 215 and the analysis system 32 reconstructs the fax-email message and forwards the same to the recipient. In this manner, the intended recipient receives the integrated facsimile communication in his or her email message mailbox as an email attachment. While method 200 is described as using one phone system 26, one email communication system 28, and one analysis system 32, method 200 can use any number of the phone systems 26, email communication systems 28, facsimile systems and analysis systems 32, all of which may feed into a single database or multiple databases. Further, method 200 can be used for any type of electronic communication (e.g., and without limitation, text messages) or any other type of communication or transmission of information that exists now or may exist in the future. (e.g., and without limitation, letters).

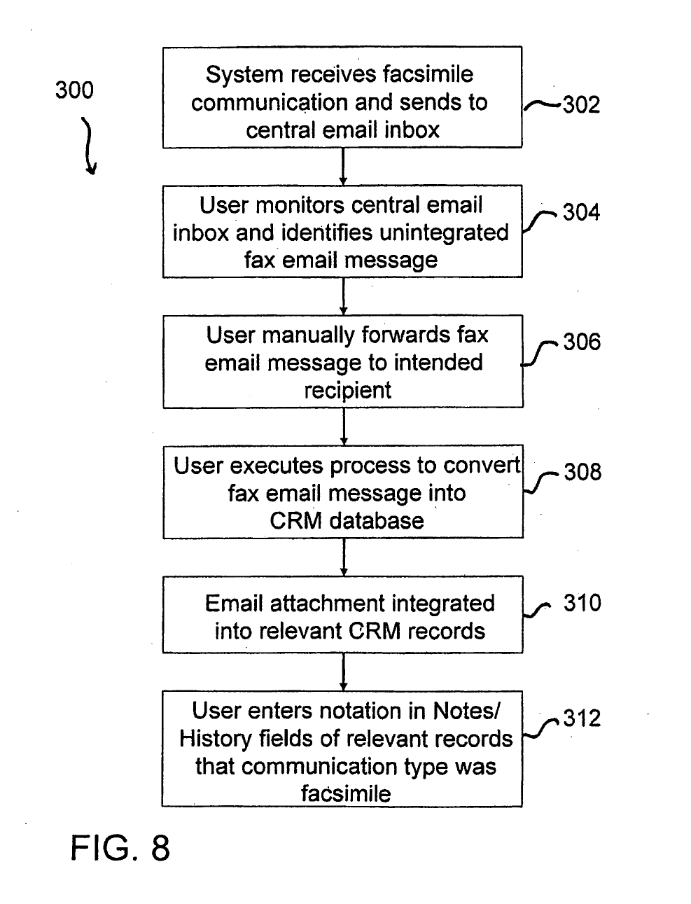

When a facsimile is intended for a particular recipient, but sent to a central facsimile number (e.g., the employees of a company do not have direct facsimile numbers), the email communication system 28 is unable to detect the identity of the intended recipient. A project management method 300 allows facsimiles intended for a specific recipient, but sent to a central facsimile number, to be associated with the correct records in the CRM 22. For example, FIG. 8 shows a flow chart of a method 300 that comprises additional steps that can be added to the method 200. As shown in FIG. 8, when the project management system 10 receives the facsimile addressed to a central facsimile number, the email address assigned to the fax-email message by the email communication system 28 is associated with a central email account, rather than the intended recipient's email address. Accordingly, at step 302, the email communication system 28 sends the fax-email message to a central email mailbox.

At step 304, a user checks the central email mailbox for new messages, identifies the unintegrated fax-email message therein, and manually skims the email attachment to ascertain the identity of the intended recipient. The user may be an administrator or any other user of the project management system 10 who has administrative access to the CRM 22. At step 306, the user obtains the intended recipient's email address and forwards the fax-email message to the intended recipient via the email communication system 28. At step 308, the user executes a process to convert the email-fax message into a format readable by the CRM database. In one embodiment, the user can drag-and-drop the email attachment of the fax-email message into a CRM file. The CRM 22 thereafter prompts the user to manually enter the recipient's and sender's name into the CRM 22 such that the CRM 22 can identify the correct records in the CRM database and appropriately catalogue the facsimile communication.

Once the correct records in the CRM database are identified, the email attachment is integrated into the records at step 310. This may be completed manually or through an automated process. Whether an automated or manual process is used to integrate the email attachment in the CRM database, the date and time of when the facsimile was actually received by the project management system 10 is the date/time stamp that is integrated into the CRM database. In this manner, any delay on behalf of the user in initiating the integration of the facsimile into the CRM 22 does not affect the accuracy of the records within the CRM 22. At step 312, the user enters a notation in the applicable “Notes/History” fields indicating that the communication type was a facsimile.

By storing the detailed phone, email, and facsimile information within the CRM 22, the methods 100, 200, and 300 automatically create up-to-date, detailed accounts of every communication that goes through the project management system 10. In addition, the CRM 22 may be accessible such that a user can review the project activity and analysis results stored in the CRM database at any time. In one embodiment, only the project managers and administrators may have complete access to the CRM 22 for security purposes. This enables a project manager to easily determine which individuals are working on a project during a specified time period due to their communication activity.

In step 108 of the method 100, the analysis system 32 is further capable of performing an activity analysis on the records with respect to specific teams, clients, or projects. The activity analysis is a function of the analysis system 32 and is capable of 1) analyzing the communications of a specific team, client, or project and presenting such information in a comprehensive report (the “Reporting Function”), and 2) issuing warnings if a trigger event occurs (the “Warning Function”). The Reporting Function of the activity analysis analyzes specific records within the CRM database pursuant to a set of rules defined by a project manager or administrator. For example, a project manager may define a set of rules that instructs the analysis system to run an activity analysis on all parties within the CRM database who are associated with a particular client project.

Different sets of rules may be saved as independent types of activity analyses. For example, one type of activity analysis may be set to only analyze the CRM database records for activity or inactivity on a particular project (the “Active/Inactive Analysis”). The Reporting Function of the Active/Inactive Analysis may be used to determine if work is being done on a project (e.g., tracking phone logs, email messages, and facsimiles) or if the project is currently under a stop work order. The Reporting Function of the Active/Inactive Analysis can be specifically tailored based on the particular needs of a project. Specifically, the Reporting Function may be segmented according to which stage the project is currently in. In this manner, the Reporting Function of the Active/Inactive Analysis can monitor and provide a focused report on the communication between relevant parties in a given stage of the project. For example, as most communication occurs between the management team and the client at the “Sales” and “Quote” stages, the Reporting Function can be configured to disregard any communication between team affiliates and the client and only evaluate communication between the management team and the client when the project is in such stages. Similarly, when the project is in the “Project” stage, the Reporting Function can be configured to evaluate all communication between the team members (both management and affiliates) and the client.

Another type of activity analysis can identify the various types of communication that have occurred with the client, and at what stage of the project such communication has occurred (the “Communication Type Analysis”). In most projects, the necessity for communication with the client varies throughout the different stages of the project. As previously noted, certain project stages may require that the management team be more active in communicating with the client (e.g., Sales and Quote stages), while other project stages may require more affiliate team member communication (e.g., Project or Production stages). The Communication Type Analysis can be useful to monitor whether or not the management team and affiliates assigned to a project are communicating with the client in an effective manner during the various stages of a project.

Yet another type of activity analysis may be configured to only analyze specific communications in order to ensure that client communications are returned within a specified period of time (the “Non-Responsive Analysis”). The Reporting Function of the Non-Responsive Analysis may be used to determine if an individual or team is adequately supporting and responding to client communications. The Active/Inactive Analysis, the Non-Responsive Analysis, and the Communication Type Analysis are only three examples of different types of activity analyses, and there may be any number of independent activity analyses run by the analysis system 32. In this manner, a user can utilize the analysis system 32 to provide comprehensive information on specific points of interest within the numerous records of the database.

Once the activity analysis is complete, the analysis system 32 creates a comprehensive report delineating the results of the analysis. For the Activity/Inactivity Analysis, this report identifies all of the electronic communications that occurred between parties related to the specified client project. For the Non-Responsive Analysis, this report identifies the communications that have not been responded to in a satisfactory amount of time. For the Communication Type Analysis, the report identifies if sufficient types of communication have occurred between the relevant parties during a specified timeframe. The analysis system 32 may perform the activity analyses periodically, and in one embodiment, the activity analyses are performed concurrently after the close of business. Where the analyses occur after the close of business, the analysis system 32 emails copies of the reports to each of the individuals listed on the Warning List of the project tab once the reports are completed. In this manner, the project managers and/or management team associated with a project may be provided with daily, accurate status information regarding projects of interest.

The Reporting Function provides project managers and administrative staff the ability to determine who is working and when, whether or not adequate communication is being made with the client, and any other statistics of interest with respect to client and team communication. In the event the records indicate there is a lull in activity (i.e. a decrease or lack of communication between team members and/or the client), the project manager is immediately able to determine the cause of the hindrance and keep the project moving forward. Accordingly, the activity analysis allows a project manager and project team to identify a potential project impediment and provide an explanation to the client for any delays.

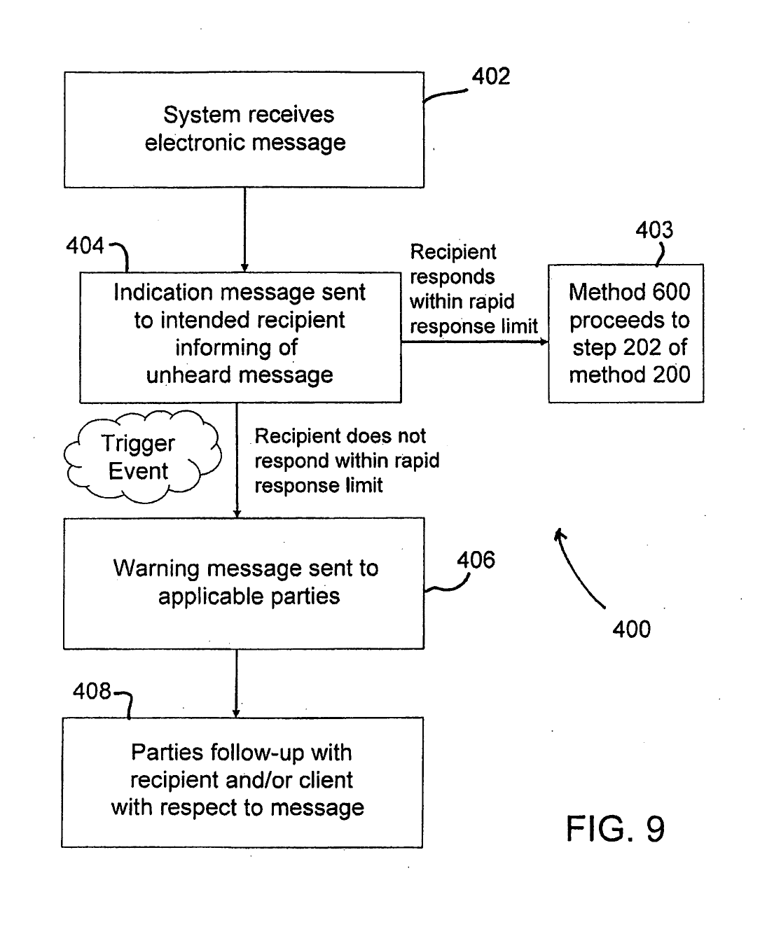

In addition to the communications management functionality of the Reporting Function, a user can utilize the Warning Function of the analysis system 32 to monitor the activities of team members and dictate the response rate in which a team member must respond to a client's inquiry. FIG. 9 shows a flow chart of a project management method 400 for alerting the proper individuals in the event of a change in project status occurs (e.g., the Active/Inactive Analysis), if an email or voicemail recipient fails to respond to an electronic communication in the desired amount of time (e.g., the Non-Responsive Analysis), or if adequate voice communication has not occurred within the desired amount of time (e.g., the Communication Type Analysis). The method 400 uses at least one set time limit—the rapid response limit—to measure the recipient's response time and inform the requisite parties if there is a delayed response or inadequate communication. The steps of the method 400 can be added to the previously explained methods.

As shown in FIG. 9, at step 402, a voicemail message is sent through the phone system 26 and received by the recipient's voicemail inbox. Upon receipt, the analysis system 32 immediately sends an indication message to the intended recipient at step 404. The indication message may be a page, a telephone communication sent to the recipient's alternative phone number (e.g., a mobile phone), and/or an email message sent to the recipient's email address. For example, when an individual receives a voicemail message, the analysis system 32 sends an indication message to the recipient's alternative phone number and/or the recipient's email address indicating that he or she has an unheard voicemail message.

In the event the analysis system 32 sends an indication message in the form of a telephone call and receives the recipient's voicemail system on the alternative phone, the analysis system 32 leaves a voicemail message indicating that the recipient has an unheard voicemail message. Thereafter, the analysis system 32 continues to call, page, and/or email the recipient at set intervals with a reminder that the recipient has unheard messages. It is understood that the interval between the reminder messages may vary depending on what time frame is desired. For example, the reminder messages may be scheduled to call and/or page the recipient every two (2) hours. If, after the indication message(s) is sent, the recipient addresses and responds to the original message within the rapid response time limit, the method 400 does not proceed to step 406 and instead reverts to step 403. At step 403, no further indication messages are sent and the project management method 200 is initiated by the recipient sending a new message in response to the one he or she received.

The rapid response limit is the amount of time in which a recipient must respond to a client communication. It will be appreciated that the rapid response limit may be set at any period of time. For example, the rapid response limit may be regulated by a project manager or coordinator and manipulated based on the client's desires and/or the requirements of the project. In one embodiment, two pre-set rapid response limits are available for use: a standard rapid response limit of five (5) calendar days and a high priority rapid response limit of one (1) calendar day. When a particular project is under an immediate crisis, the project manager can set the rapid response limit to high priority, which will promote all of the team members to focus their attention to that particular project until the crisis is resolved.

In the event the recipient fails to access and respond to the original message within the applicable rapid response limit, a trigger event is satisfied and the method 400 proceeds to step 406. At step 406 the analysis system 32 sends a warning message to the individuals listed on the Warning List of the project tab. The warning message informs the individuals on the Warning List that a message has been received, but not adequately addressed within the rapid response limit, and may be in the form of an email message, a call, a page, or anything else known in the art that will adequately alert the applicable individuals as to the status of the event. At step 408, the individuals on the Warning List who received the warning message ensure that the client receives a follow-up to his or her communication. In this manner, the method 400 allows a project manager and team to maintain the highest level of client service by ensuring that all voicemail and email messages received by the project management system 10 are promptly addressed. Similarly, if a trigger event is defined as “no activity on a project for five (5) days”, and a five (5) day lull in activity is detected, the individuals on the Warning List are immediately sent a warning message and thereby informed of the occurrence of the trigger event.

By performing this Warning Function of method 400, a user may use the project management system 10 to monitor project activity, ensure timely progress and accountability of multiple project teams, ensure continuous and/or effective communication with clients, and prioritize rapid response to client inquiries. In one embodiment, method 400 may be used in conjunction with general project tasks as well as communications. For example, deadlines for different phases of a project may be saved on the project tab as trigger events. If the requisite tasks or milestones have not been completed prior to the occurrence of a deadline, a trigger event is satisfied. The trigger event activates method 400 to send warning messages to specified parties (e.g., the individuals listed on the Warning List) indicating that a deadline has not been met.

The Warning Function of method 400 may also be used in conjunction with the Communication Type Analysis. For example, the trigger event can be set to occur when at least one voice communication does not occur with a client during a specified timeframe. The specified timeframe may be any period of time desired, and in one embodiment, the specified timeframe may be about two times the rapid response limit used with the Warning Function of the Non-Responsive Analysis. Accordingly, if a voice communication does not occur between the client and a project team within the specified timeframe, the trigger event is satisfied and the method 400 advances to step 406. As previously described, the trigger event activates method 400 to send warning messages to the specified parties (e.g., the individuals listed on the Warning List) indicating that adequate communication has not occurred.

The method 400 may be used to send many different types of warning messages, so long as the warning messages are initiated based on the occurrence of a trigger event and the trigger event is sufficiently defined. It will be appreciated that by performing the project management method 400 and keeping project leaders informed, client relationships will be strengthened and the highest levels of project supervision and efficiency can be obtained.

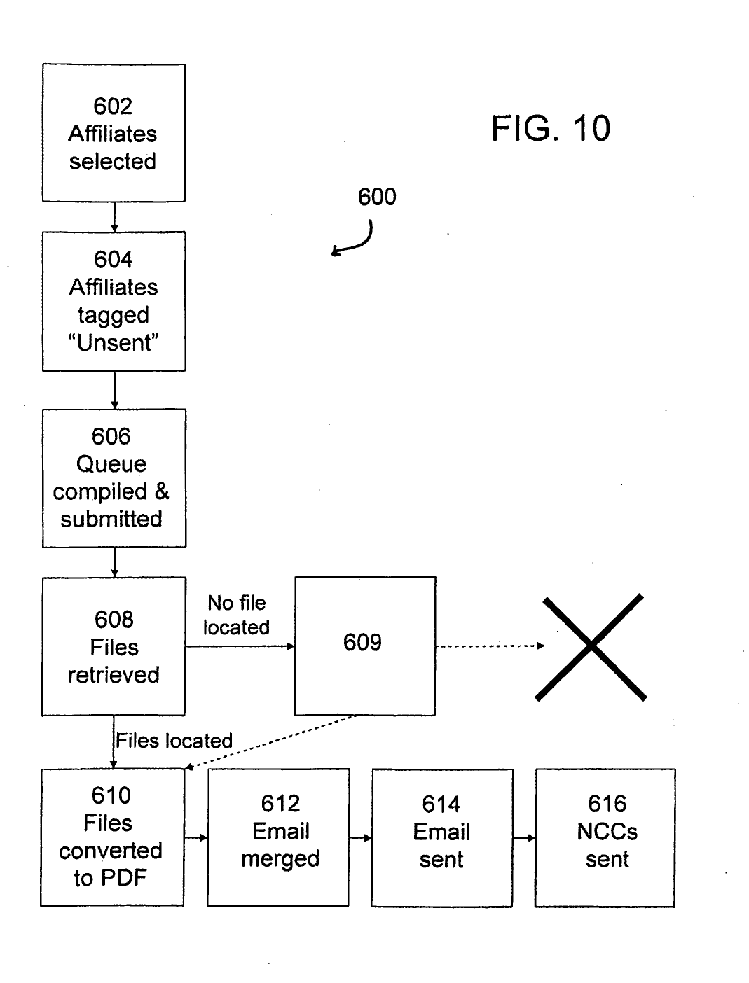

Now referring to FIG. 10, a flow chart is shown of another embodiment of the project management method 600. As previously discussed, FIG. 11 shows the project management system 10 with one of the applications 20 comprising the résumé and notice of client contact (“NCC”) automation system 500. The method 600 uses the résumé and NCC automation system 500 to notify affiliates of project opportunities and/or send out affiliate résumés to client contacts for review. For ease of understanding, the steps of the related methods described herein will be discussed relative to the components of the project tab and/or the project sub-tab described above, however, it will be appreciated by one skilled in the art that any such graphical user interface or application may be used to perform these methods so long as it has access to a server, various applications to send and receive electronic communications, and can be used to execute the necessary steps.

Generally, a user can utilize the résumé and NCC automation system 500 to interface with the CRM 22 and retrieve files associated with specific affiliates (i.e. “Contact” records). Further, the résumé and NCC automation system 500 can interface with the email communication system 28 such that such files are automatically sent to the selected affiliates or a third party such as a client. For example, the résumé and NCC automation system 500 may be used to send a list of résumés to a client for review prior to assigning team members and initiating a project. Alternatively, the system 500 can send a notice of client contact to a group of affiliates who may be interested in participating in an upcoming project.

In one embodiment, the résumé and NCC automation system 500 uses the “Project Associates” sub-tab of the project tab (an example of which is shown in FIG. 5). As shown in FIG. 10, at step 602 a user can select affiliates to join a project team by accessing the “Contact Search” field of the “Project Associates” sub-tab. A specific affiliate can be selected by performing a name-based or other data search of the CRM database. For example, a user may type in an affiliate's last name into the “Last Name” subfield. Thereafter, when the user clicks “OK” or any other activation button as is known in the art, the résumé and NCC automation system 500 requests the records associated with the selected affiliate from the CRM database. It will be understood that the term “affiliate” is used herein in a non-limiting fashion and may encompass any person whose information can be accessed by the project management system 10. For example, an affiliate may be an employee, an independent contractor, or any other entity that can be staffed on a project.

When the correct “Contact” record is located, at step 604 the “Résumé/NCC Status” field of the “Contact” record is set to “Unsent”. This may occur automatically when the Contact is selected or a user may manually select “Unsent” from the drop down menu in the “Résumé/NCC Status” field of the “Contact” record and thereafter click “OK” or any other activation button. In this manner, a specific affiliate can be tagged as needing a résumé to be sent out to a particular client regarding a particular project. This also links the affiliate to the “Project Associates” sub-tab so that the affiliate is included in the Résumé/NCC process for a specific project.

Steps 602 and 604 are repeated for each affiliate that the user desires to add to the project. After an adequate list of affiliates is compiled, the user may then, at step 606, select the “Send Unsent Résumés” command from the Project Commands section of the project tab and click the “Submit” button (for example, see Project Commands section 712 in FIG. 5). Prior to proceeding to step 608 and processing the résumés and/or NCCs, the résumé and NCC automation system 500 verifies that the requisite information has been supplied. In one embodiment, the résumé and NCC automation system 500 runs a series of checks, including verification that a Project Title and Project Description have been supplied and that both a Lead Consultant 1 and a Lead Consultant 2 have been designated. Further, the status of each affiliate added to the queue is assessed to ensure that the selected affiliates are available. For example, if a selected affiliate's status is listed as “Hold”, the system 500 can be directed to initiate a pop-up notification to the user regarding the Hold status of the affiliate. It will be understood that the parameters of the verification tasks may be independently set by the user. In this manner, the verification parameters can be tailored to fit the needs of particular clients and/or specific projects.

At step 608 the résumé and NCC automation system 500 sends a request to a database 60 to obtain the desired résumé files. Specifically, for each of the affiliates tagged at step 604, the system 500 retrieves his or her résumé file(s) from a database 60. In one embodiment, the database 60 may comprise a particular résumé drive on a server. For example, the résumé and NCC automation system 500 may be programmed to interface with a résumé folder on the “K:” drive and request a résumé matching the “LastName.FirstName×Ext” of each affiliate listed in the queue. In the event the system 500 retrieves a single résumé for each tagged affiliate, the method 600 proceeds using each of the retrieved resumes. In certain circumstances, multiple résumés may be associated with a single affiliate. This may happen, for example, if an affiliate has more than one résumé stored within a database 60. If the résumé and NCC automation system 500 retrieves multiple résumé files for a single affiliate, in one embodiment, a pop-up notification appears that lists each of the multiple résumé files. Accordingly, the user can review the list and select the desired résumé to send to the client. If the user does not wish to select any of the listed résumé files, the user cancels the process with respect to the particular affiliate at issue and no résumés or NCCs will be sent.

In the event the résumé and NCC automation system 500 is unable to locate a file matching a particular tagged affiliate at step 608, the method 600 advances to step 609. At step 609, the user receives a message indicating that at least one of the tagged affiliates does not have a matching resume. At this point, the user may either select to cancel the method 600 altogether (even with respect to those affiliates for which résumés were successfully retrieved), or remove the offending affiliate from the queue and proceed with respect to other affiliates. Additionally, a user may set the status of the unmatched affiliate to “Hold”, and instruct the system 500 to proceed with respect to the other affiliates for which files were successfully retrieved. In one embodiment, if any of the tagged affiliates display a status of “Hold”, a pop-up notification appears to inform the user of the same and indicate that the status issue should be addressed as soon as possible.

Once a résumé file has been retrieved for each of the tagged affiliates, the method 600 advances to step 610. At step 610, the résumé and NCC automation system 500 converts each of the retrieved files into .PDF documents or any other types of file that may be desired. In one embodiment, the résumé files originally comprise Word documents and are converted into .PDF documents using the activePDF Server and DocConverter applications. The conversion of the résumé files may occur immediately or take up to about thirty (30) sections per file, depending on the processing load on the server. In one embodiment, as the system 500 is in the process of converting each of the files, a display may be shown indicating the status of the conversion(s). During the course of the document conversion, the documents are copied between various folders on the server as is known in the art. In the event the system 500 is unable to successfully convert a particular file into a .PDF document, an error message will pop-up and notify the user who can either initiate step 610 again, or cancel the method 600.

After the files are successfully converted into .PDF documents, the résumé and NCC automation system 500 interfaces with the email communication system 28 at step 612, and merges an email template with the data from the records of the CRM 22 and the project tab. Accordingly, an email window appears, the résumé and NCC automation system 500 automatically retrieves the client contact's email address from the CRM 22 “Accounts” records, and the email address is inserted into the “To:” line of the email message. In addition, the user may manually add any number of email addresses to the email message, should the user desire to copy any other parties (e.g., the Lead Consultant, etc.) on the communication. The “Subject” and “Body” of the email message are based on the Mail Merge Template, which may be any email template known in the art and can be tailored based on the client's needs. Further, a .PDF version of the files of each affiliate tagged at step 604 are attached to the email message.

The résumé and NCC automation system 500 can use any email template that is known in the art, and in at least one embodiment, the system 500 may select from four (4) different email templates to distribute the résumé files. For example, one email template may be designed for use the first time résumés are sent to a client for a new project, when the user who is initiating the process is also the Lead Consultant. In another example, the system 500 may be programmed to use a second template when it is the first time résumés are being sent to a client for a new project and such résumés are being sent by an administrative user. Still further, the system 500 may select a third template designed for the Lead Consultant to convey additional résumés to a client after initial communication regarding a particular project has already occurred. Alternatively, a fourth template may be tailored for an administrative user to use when sending additional résumés to a client after initial communication regarding a particular project has already occurred.

While various specific templates are described herein, it will be appreciated that any email template may be designed for use by the system 500. Specifically, in one embodiment of the project management system 10, a user may prepare a number of templates which can be linked to various conditions through the system's 10 Administration Console form. In this embodiment, the Administration Console form comprises an electronic form that allows a user to link specific email templates to specific conditions. For example, a user may set a specific email template to be automatically used every time the Lead Consultant sends new résumés to a client. In at least one embodiment, a user can set each template by clicking on the folder button next to the respective field and thereafter locating and selecting the appropriate email template.

At step 614, the user sends the email by a process that is known in the art. After the email message has been sent, the “Last Résumés Created” field of the project tab is automatically updated to the date and time the email message was successfully sent and integrated into the CRM 22. The automatic population of the “Last Résumés Created” field functions to assist with the validation processes discussed in more detail herein, as this data represents the time at which the method 600 was last run successfully and the called résumés were sent through the email communication system 28. As previously described with respect to the method 200, when the email message having the .PDF file attached is sent, the email message is integrated into the CRM 22 and the applicable records for the email sender and recipients are updated. Further, in one embodiment, a notation is inserted into the “Notes/History” field for each of the tagged affiliates' records. In this embodiment, the “Last Résumé Sent” field of the project tab may also be updated for each affiliate each time a résumé is processed and sent by the system 500.

At step 616, the résumé and NCC automation system 500 again interfaces with the email communication system 28. The NCCs are queued up to be sent for those affiliates whose “Résumé/NCC Status” fields on the “Project Associates” sub-tab comprise an “Unsent” value. A background process of the system 500 that runs about every ten (10) minutes reads from the queue, automatically creates an email message, and sends NCCs to the affiliates whose resumes were sent.

In one embodiment of the résumé and NCC automation system 500, there are five (5) different versions of the NCC available to be sent to the affiliates; the various NCCs versions differing in that each version is tailored to convey project information based on the affiliate's designated position (e.g., Lead Consultant 1, Lead Consultant 2, Employee, Associate Company, Associate Individual, etc.). For example, if the tagged affiliate that was added to the queue in step 602 is designated as a Lead Consultant 1 on the project tab, a version of the NCC tailored to the Lead Consultant 1 position will automatically be sent to that affiliate. After the NCCs have been sent to the appropriate affiliates, the “Résumé/NCC Status” field of each of the affiliate's “Notes/History” table is automatically updated to “Sent”.

In an alternative embodiment, the résumé and NCC automation system 500 is capable of recognizing responses to the original email messages sent out to the affiliates containing the NCC by Subject Line recognition or otherwise. This may occur, for example, if an affiliate receives an email message having an NCC attached thereto and the affiliate is interested in obtaining more information about the project. In this embodiment, if an email message received by the system 10 is determined to be a response to an email message sent to an affiliate containing an NCC, the résumé and NCC automation system 500 can immediately send a form email message to the affiliate thanking them for their interest and providing more details about the project.

The résumé and NCC automation system 500 further comprises at least two validation processes to ensure that the distribution of both the résumés and NCCs properly occurs. For example, a periodic process may be utilized to verify that the email messages having the resumes attached have been successfully sent (e.g., nightly, daily or other user defined time period). In this embodiment, one check may periodically compare the values of the “Last Résumés Created” fields against the values of the “Last Résumé Sent” fields. In the event the check identifies a project governed by the system 10 that does not have a “Last Résumé Sent” date that is greater than the “Last Résumés Created”, the system 500 interfaces with the email communication system 28 of the system 10 and sends a warning email to the Lead Consultant 1, the Lead Consultant 2, and Project Coordinators 1-4 indicating that the résumés were not successfully sent for a particular project. In this embodiment, a second validation process will run an hourly process that identifies whether or not any active projects have affiliates whose “Résumé/NCC Status” fields comprise an “Unsent” value. In the event an NCC has not been sent, a notification email message is prepared through the email communication system 28 to the Lead Consultant 1, the Lead Consultant 2, and the PC1-4 indicating the same.

The systems and methods described herein are only offered by way of non-limiting examples, as other versions are possible. For example, methods 100, 200, 300, 400, and 600 are not just limited to client service applications, but may be used for a number of different project-related ventures. Many variations and modifications of the embodiments described herein will be apparent to those of ordinary skill in the art in light of the disclosure. It will therefore be understood by those skilled in the art that various changes and modifications may be made, and equivalents may be substituted for elements thereof, without departing from the intended scope. Indeed, this disclosure is not intended to be exhaustive or to limit the scope of the embodiments. The scope is to be defined by the appended claims, and by their equivalents.

Further, in describing representative embodiments, the disclosure may have presented a method and/or process as a particular sequence of steps. However, to the extent that the methods or processes do not rely on the particular order of steps set forth herein, the methods or processes should not be limited to the particular sequence of steps described. As one of ordinary skill in the art would appreciate, other sequences of steps may be possible. Therefore, the particular order of the steps disclosed herein should not be construed as limitations on the claims. In addition, the claims directed to a method and/or process should not be limited to the performance of their steps in the order written, and one skilled in the art can readily appreciate that the sequences may be varied and still remain within the spirit and scope of this disclosure.

1. A method for project management, the method comprising the steps of:
providing a communication system;
receiving communications through the communication system;
converting the communications into at least one electronic medium;
extracting relevant information from the converted electronic communications;
storing the relevant information in a database;
automatically populating at least one defined field of a management system with the relevant information; and
monitoring the frequency of communications with the management system.

2. The method for integrated project management of claim 1, further comprising the steps of:
establishing at least one milestone for a project; and
assessing the stored information to determine a status of the project relative to the at least one milestone.

3. The method of claim 1, further comprising the steps of:
defining at least one required response time to the communications received through the communication system;
identifying at least one party; and
issuing an alert to the at least one party in the event the communication is received by the communication system and not responded to within the required response time.

4. The method of claim 1, further comprising the steps of:
evaluating the relevant information stored in the database on a periodic basis;
creating a report indicating any detected changes in the stored information; and
sending the report to a plurality of specified parties.

5. The method of claim 1, wherein the step of monitoring the frequency of communications with the management system further comprises the steps of:
identifying a first party, a second party, and a client;
monitoring the communications between the first party and the client based on the relevant information during a first stage of a project; and
monitoring the communications between the second party and the client based on the relevant information during a second stage of the project.

6. The method of claim 5, further comprising the steps of:
identifying a required response time;
identifying a third party to be notified; and
issuing a communication to the third party in the event the communications between the first party and the client does not comprise a telephonic communication within the required response time.

7. The method of claim 1, wherein the communications comprise electronic-mail based communications.

8. The method of claim 1, wherein the communications comprise telephone based communications.

9. The method of claim 7, wherein the communications further comprise telephone based communications.

10. The method of claim 1, wherein the communications further comprise facsimile based communications.

11. The method of claim 1, wherein the relevant information comprises an identification of the parties to the communications, a time at which the communications were made, and a date on which the communications were made.

12. The method of claim 1, further comprising the steps of:
selecting at least one individual to participate on a project;
retrieving at least one résumé for each of the at least one individuals from the database;
attaching the résumés to a communication; and
sending the communication to at least one client for the project.

13. The method of claim 12, further comprising the steps sending each of the individuals a communication regarding the project.

14. The method of claim 12, further comprising the step of validating that the communication was sent to the at least one client.

15. A management system comprising:
a server network;
a plurality of personal computer terminals operatively coupled with the server network;
a plurality of applications coupled with the server network;
an intranet system coupled with the server network and the plurality of applications; and
at least one database, each of the at least one databases operatively coupled with the server network and capable of being accessed thereby.

16. The management system of claim 15, wherein at least one of the plurality of applications comprises a client relationship management system, at least one of the plurality of applications comprises a phone system, at least one of the plurality of applications comprises an email communication system, and at least one of the plurality of applications comprises an analysis system.

17. The management system of claim 16 wherein each of the applications are coupled with each other and capable of communication therebetween.

18. The project management system of claim 16, wherein at least one of the plurality of applications comprises a résumé and notice of client contact automation system.

19. The project management system of claim 18, wherein the résumé and notice of client contact automation system is operable to retrieve a file from the databases, retrieve relevant information from the databases, and interface with the email communication system such that a communication based on the relevant information and having the file attached can be sent.
